(19) United States
(12) Patent Application Publication
(10) Pub. No.: US 2012/0105373 A1
(43) Pub. Date: May 3, 2012

(54) METHOD FOR DETECTING TOUCH STATUS OF SURFACE OF INPUT DEVICE AND INPUT DEVICE THEREOF

(76) Inventors: Chih-Min Liu, Grand Cayman (KY); Yi-Cheng Chou, Grand Cayman (KY)

(21) Appl. No.: 12/916,593

(22) Filed: Oct. 31, 2010

(51) Int. Cl. G06F 3/042

(52) U.S. Cl. 345/175

(57) ABSTRACT

A method for detecting a touch status of a surface of an input device, comprising: utilizing a first two-dimension (2D) image sensor disposed at a first location for capturing a first captured image of an object on the surface; and outputting a plurality of first positions of the object relative to the surface respectively by analyzing horizontal lines of the first captured image.

### BACKGROUND OF THE INVENTION

1. Field of the Invention

The invention relates to touch status detection, and more particularly, to a method for detecting a touch status of a surface of an input device and the input device employing the method.

2. Description of the Prior Art

Touch panels are widely used in various consumer electronic products, which allow users to use fingers or touch pens to select desired images or characters from the screen and input information and perform operations by touching the touch panel screen.

Traditional touch panels are divided into various types according to different sensing methods. By way of example, a touch panel may be a resistive type touch panel or a capacitive type touch panel. Resistive type touch panels are composed of two indium tin oxide (ITO) conductive films stacked on top of one another, wherein by applying pressure to electrically connect the two conductive films, a controller is used to measure the voltage difference of the panel and calculate the coordinates of a touch input. Capacitive type touch panels are composed of transparent glass substrates and an oxide metal coated on a surface of the glass substrate. The sensing structures of the capacitive type touch panels are composed of two electrode layers electrically connected along an x-axis direction and a y-axis direction, respectively, and an insulating layer is disposed between the two electrode layers such that the capacitive difference generated by an electrostatic reaction from the fingers of a user and an electrical field is used to determine a touch input.

In recent years, an optical sensor used in a touch panel has been devised. It is more suitable and economical to use in a large area touch panel. When manufacturing large area touch panels, there is a proportional increase in the cost of “sensing” material (e.g., ITO conductive films) of the resistive type or capacitive type touch panels. Because there is no “sensing” material in an optical touch panel, increasing the size of the touch panel does not result in a proportional increase of the manufacturing cost of the optical touch panel. Some conventional optical touch panels use one dimension (1D) barcode readers or special designed linear optical sensors as a touch detecting sensor. However, the above-mentioned optical touch panels cannot sense the touch pressure or stroke intensity of drawing. Furthermore, the linear optical sensor is long and thin which is hard to slice and lay out, thereby requiring higher manufacturing cost.

### SUMMARY OF THE INVENTION

It is therefore one of the objectives of the present invention to provide a method for detecting a touch status of a surface of an input device and the input device employing the method, to solve the above mentioned problem.

According to a first embodiment of the present invention, an exemplary method for detecting a touch status of a surface of an input device, the method comprises: utilizing a first two-dimension (2D) image sensor disposed at a first location for capturing a first captured image of an object on the surface; and outputting a plurality of first positions of the object relative to the surface respectively by analyzing horizontal lines of the first captured image.

According to a second embodiment of the present invention, an exemplary method for detecting a touch status of a surface of an input device, comprising: utilizing a 2D image sensor disposed at a first location for capturing a first captured image of an object on the surface, wherein the object have a first part and a second part, wherein the second part has different optical characteristic from that of the first part; and outputting a touch pressure by a vertical position of the first part in the first captured image.

According to a third embodiment of the present invention, an input device is disclosed. The input device comprises a first 2D image sensor and a touch controller. The 2D image sensor is disposed at a first location of a surface, for capturing a first captured image of an object on the surface. The touch controller is for outputting a plurality of first positions of the object relative to the surface respectively by analyzing horizontal lines of the first captured image.

According to a fourth embodiment of the present invention, an input device is disclosed. The input device comprises an object, a 2D image sensor and a touch controller. The object has a first part and a second part, wherein the second part has different optical characteristic from that of the first part. The first 2D image sensor disposed at a first location of a surface, for capturing a first captured image of the object on the surface. The touch controller is for outputting a touch pressure by analyzing a vertical position of the first part in the first captured image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an input device according to an exemplary embodiment of the present invention.

FIG. 2 is a diagram illustrating an input device according to another exemplary embodiment of the present invention.

FIG. 3 is a diagram illustrating an input device according to yet another exemplary embodiment of the present invention.

FIG. 4 is a flowchart illustrating a method for detecting a touch status of a surface of an input device according to an exemplary embodiment of the present invention.

FIG. 5 is a flowchart illustrating a method for detecting a touch status of a surface of an input device according to another exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

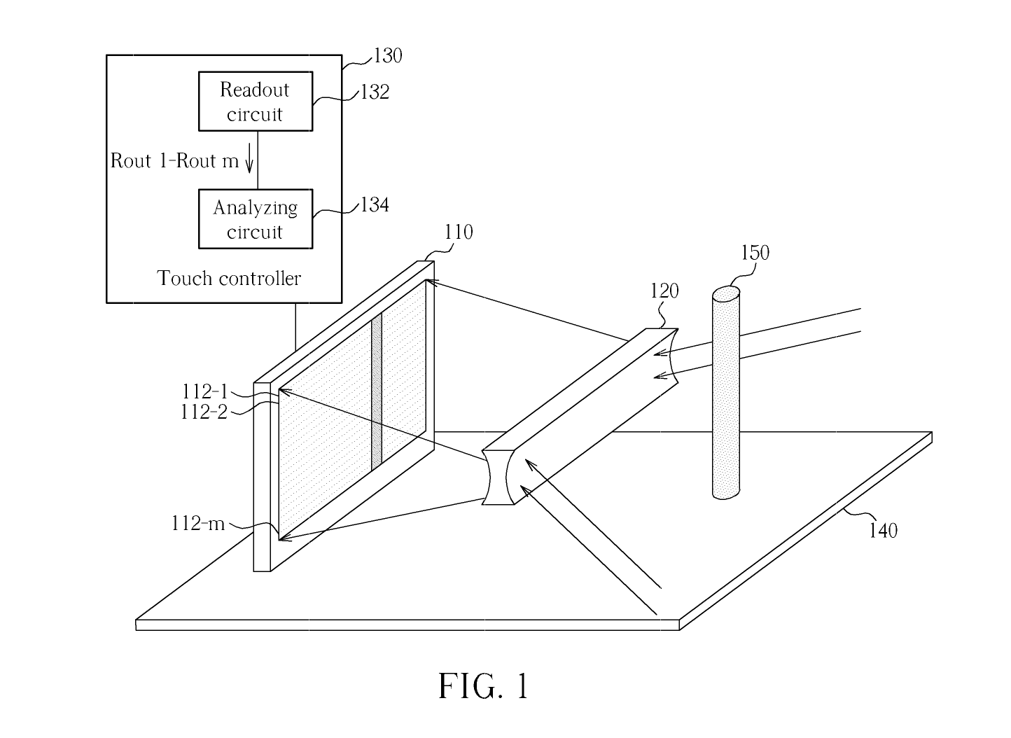

Please refer to FIG. 1. FIG. 1 is a diagram illustrating an input device 100 according to an exemplary embodiment of the present invention. The input device 100 includes, but is not limited to, a two-dimension (2D) image sensor 110, a cylindrical concave lens 120, and a touch controller 130, wherein a plate reflector (not shown in FIG. 1), e.g., a mirror, is placed correspondingly in a opposing direction to the 2D image sensor 110. The input device 100 is used on a plate 140, such as a monitor or other plane. The 2D image sensor 110 is used for capturing a first scene at one side of a surface of the plate 140 to obtain a first captured image. The cylindrical concave lens 120 is placed in front of the 2D image sensor 110, and implemented for spreading a size of an image of the first scene to be formed on the 2D image sensor 110. The touch controller 130 is coupled to the 2D image sensor 110, and implemented for analyzing at least a portion of the first captured image to detect the touch status of the surface of the plate 140. Please note that, in this embodiment, the input device 100 is an optical touch apparatus, the cylindrical concave lens 120 is an optical device which spreads the size of the image of the first scene to be formed on the 2D image sensor 110; however, this is for illustrative purposes only, and is by no means a limitation to the scope of the present invention. Using another optical device that supports the spreading capability also falls within the scope of the present invention. Moreover, the cylindrical concave lens 120 is preferably implemented to increase the image size of the first scene formed on the 2D image sensor 110; however, it may be omitted in alternative embodiments of the present invention, depending upon design considerations.

In one exemplary embodiment, the 2D image sensor 110 includes a plurality of sensor rows 112_1-112_m. The touch controller 130 includes a readout circuit 132 and an analyzing circuit 134. The readout circuit 132 is used for reading the sensor rows 112_1-112_m of the 2D image sensor 110 one by one, thereby generating a plurality of readout data Rout1-Routm. The analyzing circuit 134 is used for analyzing the readout data Rout1-Routm read by the readout circuit 132 to detect the touch status of the surface of the plate 140. As shown in FIG. 1, a touch pen 150 is shown positioned in the sensing area of the 2D image sensor 110. The cylindrical concave lens 120 spreads a size of the touch pen 150 to form on the 2D image sensor 110. The touch controller 130 reads the sensor rows of the 2D image sensor 110 one by one to generate the readout data Rout1-Routm. Then, the touch controller 130 analyzes the readout data Rout1-Routm to detect the touch position of the touch pen 150. In this exemplary embodiment, the frame rate of the 2D image sensor 110 is 30 fps (frame per second) where m is equal to 50. Therefore, the refresh rate of the input device 100 can be regarded as 1500 fps.

In another exemplary embodiment, the readout circuit 132 divides the sensor rows 112_1-112_m into n sensor groups G1-Gn. In one exemplary embodiment, m is equal to 50 and n is equal to 10. That is, the first sensor group G1 includes the sensor rows 112_1, 112_11, 112_21, 112_31, 112_41; the second sensor group G2 includes the sensor rows 112_2, 112_12, 112_22, 112_32, 112_42, and so on (please note that only two sensor groups G1 and G2 are illustrated for simplicity and clarity). However, this is for illustrative purposes only, and is by no means a limitation to the scope of the present invention. That is, m and n can be other positive integers. The readout circuit 132 reads the sensor groups G1-G10 one by one, thereby generating a plurality of readout data Rout1′-Rout10′. The analyzing circuit 134 analyzes the readout data Rout1′-Rout10′ read by the readout circuit 132 to detect the touch pressure of the surface of the plate 140.

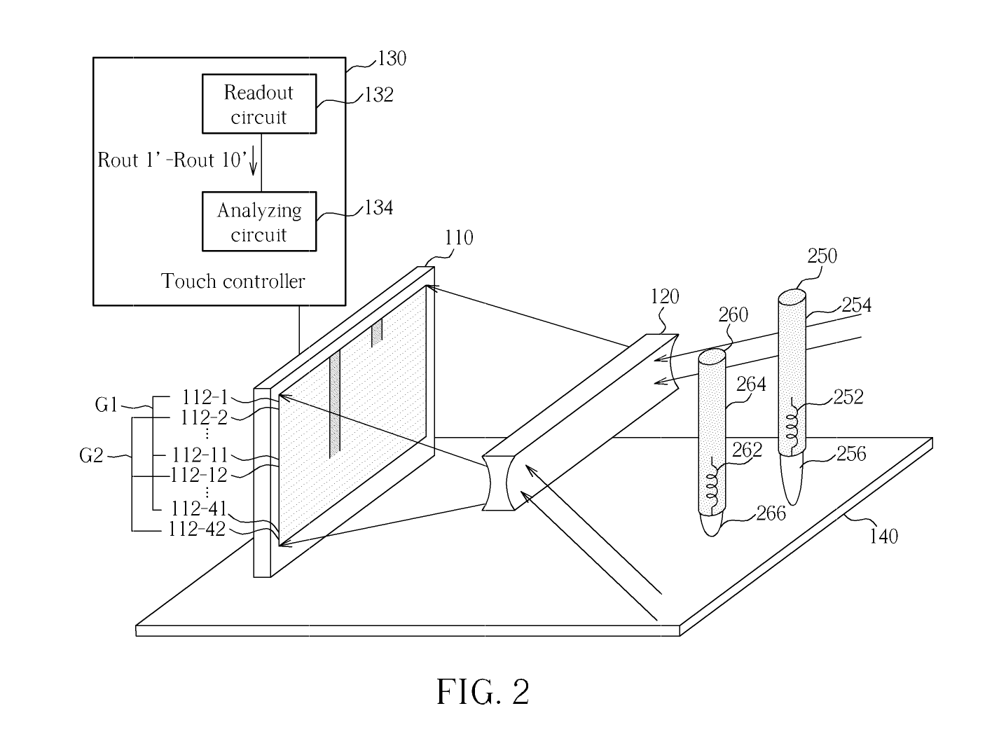

As shown in FIG. 2, two extensible touch pens 250, 260 are positioned in the sensing area of the 2D image sensor 110. The extensible touch pen 250 includes an elastic element 252, a first part 254 and a second part 256. The second part 256 is used for having a contact with the surface of the plate 140, wherein the second part 256 is movably connected to the first part 254 via the elastic element 252, and an optical characteristic of the first part 254 is different from an optical characteristic of the second part 256. In this exemplary embodiment, the elastic element 252 is a spring, the first part 254 is made of an opaque material and the second part 256 is made of a transparent material. The extensible touch pen 260 includes an elastic element 262, a first part 264 and a second part 266. The structure and material of the extensible touch pen 260 is the same as the extensible touch pen 250, so further details are omitted here for brevity.

The cylindrical concave lens 120 spreads the sizes of the images of the extensible touch pens 250, 260 to form on the 2D image sensor 110. The touch controller 130 reads the sensor groups G1-G10 one by one to respectively generate the readout data Rout1′-Rout10′. Then, the touch controller 130 detects the touch pressure of the extensible touch pens 250, 260 by analyzing the light rejection area (e.g., a dark area) and light acceptance area (e.g., a bright area) formed on the 2D image sensor 110 according to the readout data Rout1′-Rout10′. As shown in FIG. 2, the touch pressure of the extensible touch pen 260 is larger than the touch pressure of the extensible touch pen 250, therefore, the dark area formed on the 2D image sensor 110 of the extensible touch pen 260 is much longer than the dark area formed on the 2D image sensor 110 of the extensible touch pen 250, and the dark area form on the 2D image sensor 110 can be sensed by the sensor groups G1-G10 of the 2D image sensor 110. In this exemplary embodiment, the frame rate of the 2D image sensor 110 is also 30 fps and n is equal to 10. Therefore, the refresh rate of the input device 100 can be regarded as 300 fps.

Please note that, in the above-mentioned exemplary embodiment, the extensible touch pens 250, 260 are composed of three different components, but this is for illustrative purposes only, and is by no means a limitation to the scope of the present invention. For example, the extensible touch pen can be composed by a first part and a second part. The second part is made of a flexible material and connected to the first part, for having contact with the surface of the plate 140, and an optical characteristic of the first part is different from an optical characteristic of the second part. The same objective of detecting the touch pressure of the extensible touch pen by analyzing the light rejection area (e.g., a dark area) and light acceptance area (e.g., a bright area) formed on the 2D image sensor 110 is achieved.

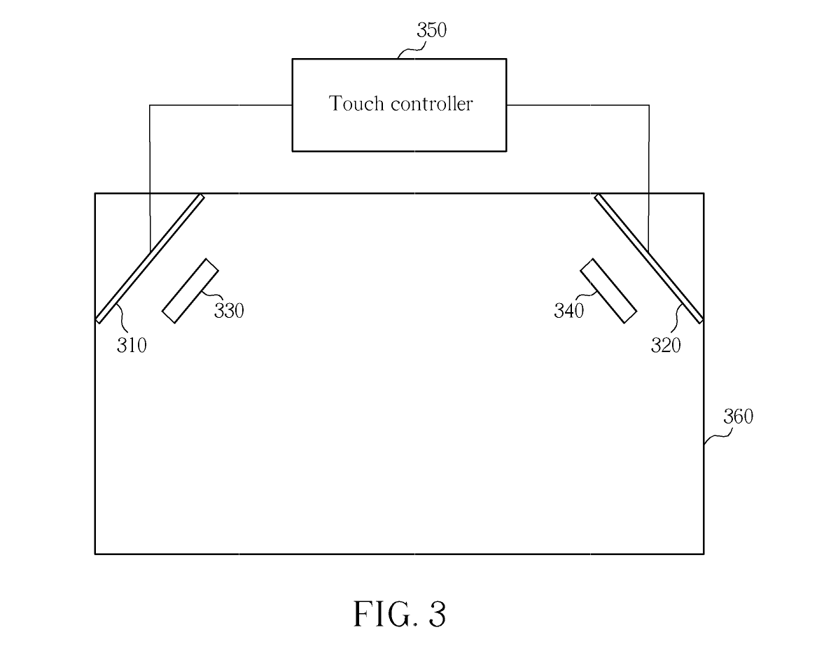

Please refer to FIG. 3. FIG. 3 is a diagram illustrating an input device 300 according to yet another exemplary embodiment of the present invention. The input device 300 includes, but is not limited to, a first 2D image sensor 310, a second 2D image sensor 320, a first cylindrical concave lens 330, a second cylindrical concave lens 340, a touch controller 350 and a plate 360, wherein two plate reflector (not shown in FIG. 3), e.g., two mirrors, are placed correspondingly in opposing directions to the first and second 2D image sensor 310 and 320, respectively. The first 2D image sensor 310 is used for capturing a first scene at a side of a surface of the plate 360 to obtain a first captured image. The first cylindrical concave lens 330 is placed in front of the first 2D image sensor 310, for spreading a size of an image of the first scene to be formed on the first 2D image sensor 310. The second 2D image sensor 320 is used for capturing a second scene at the same side of the surface of the plate 360 where the first 2D image sensor 310 is placed to obtain a second captured image. The second cylindrical concave lens 340 is placed in front of the second 2D image sensor 320, for spreading a size of an image of the second scene to be formed on the second 2D image sensor 320. The touch controller 350 is coupled to the first 2D image sensor 310 and the second 2D image sensor 320, and implemented for analyzing at least a portion of the first captured image and a portion of the second captured image to detect the touch status of the surface of the plate 360. Please note that, in this embodiment, the input device 300 is an optical touch apparatus, and the first cylindrical concave lens 330 and the second cylindrical concave lens 340 are optical devices which spread the size of the images of the first and the second scene to be formed on the first and the second 2D image sensor, respectively; however, this is for illustrative purposes only, and is by no means a limitation to the scope of the present invention. Using another optical device that supports the spreading capability also falls within the scope of the present invention. In addition, provided that the same result can be substantially obtained without one or both of the first cylindrical concave lens 330 and the second cylindrical concave lens 340, such an alternative design of omitting the cylindrical concave lens still falls within the scope of the present invention. As those skilled in this art can easily understand the operations of the input device 300 after reading the disclosure of the above-mentioned embodiments, further details are omitted here for brevity.

The abovementioned embodiments are presented merely to illustrate practicable designs of the present invention, and in no way should be considered to be limitations of the scope of the present invention. Those skilled in the art should appreciate that various modifications of the input device may be made without departing from the spirit of the present invention.

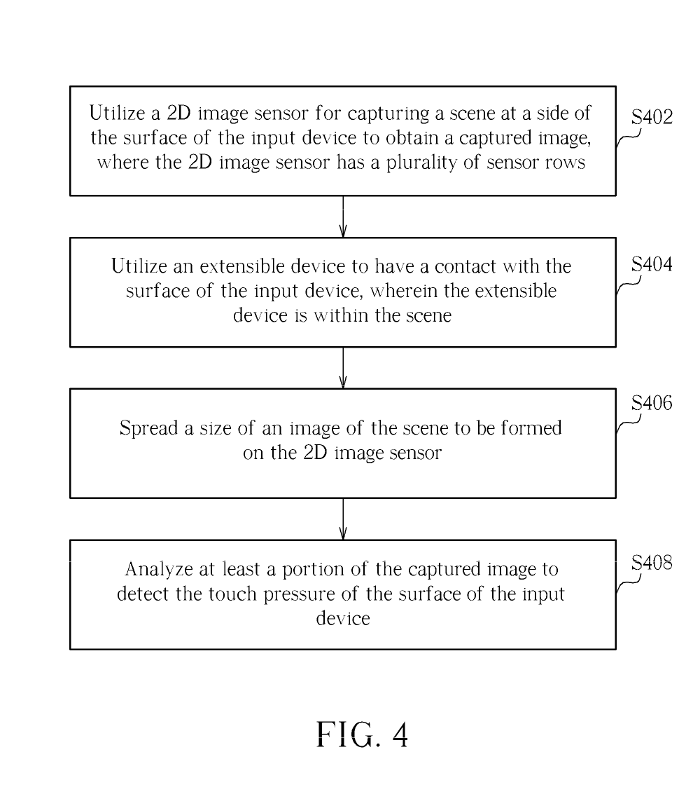

FIG. 4 is a flowchart illustrating a method for detecting a touch status of a surface of an input device according to an exemplary embodiment of the present invention. Please note that the following steps are not limited to be performed according to the exact sequence shown in FIG. 4 if a roughly identical result can be obtained. The exemplary method includes, but is not limited to, the following steps:

Step 402: Utilize a 2D image sensor for capturing a scene at a side of the surface of the input device to obtain a captured image, where the 2D image sensor has a plurality of sensor rows.

Step 404: Utilize an extensible device to have a contact with the surface of the input device, wherein the extensible device is within the scene.

Step 406: Spread a size of an image of the scene to be formed on the 2D image sensor.

Step 408: Analyze at least a portion of the captured image to detect the touch pressure of the surface of the input device.

In step 408, the sensor rows are divided into a plurality of sensor groups and are read group by group to generate a plurality of readout data. Then, the readout data are analyzed to detect the touch status of the surface of the input device. As a person skilled in the art can readily understand the related operations of the steps shown in FIG. 4 after reading the above-mentioned description directed to the input device 100 shown in FIG. 2, further description is omitted here for brevity.

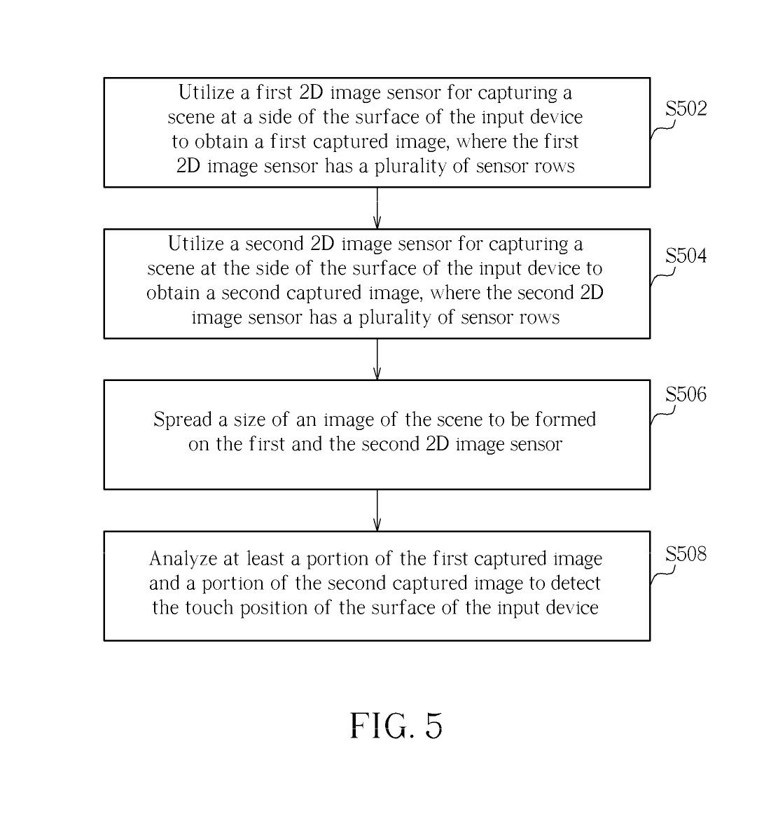

FIG. 5 is a flowchart illustrating a method for detecting a touch status of a surface of an input device according to another exemplary embodiment of the present invention. Please note that the following steps are not limited to be performed according to the exact sequence shown in FIG. 5 if a roughly identical result can be obtained. The exemplary method includes, but is not limited to, the following steps:

Step 502: Utilize a first 2D image sensor for capturing a scene at a side of the surface of the input device to obtain a first captured image, where the first 2D image sensor has a plurality of sensor rows.

Step 504: Utilize a second 2D image sensor for capturing a scene at the side of the surface of the input device to obtain a second captured image, where the second 2D image sensor has a plurality of sensor rows.

Step 506: Spread a size of an image of the scene to be formed on the first and the second 2D image sensor.

Step 508: Analyze at least a portion of the first captured image and a portion of the second captured image to detect the touch position of the surface of the input device.

In step 508, the sensor rows of the first 2D image sensor and the sensor rows of the second 2D image sensor are read one by one to generate a plurality of readout data. Then, the readout data are analyzed to detect the touch position of the surface of the input device. As a person skilled in the art can readily understand the related operations of the steps shown in FIG. 5 after reading the above-mentioned description directed to the input device 300 shown in FIG. 3, further description is omitted here for brevity.

In summary, exemplary embodiments of the present invention provide an input device and a method for detecting a touch status of a surface of the input device. By utilizing a 2D image sensor and an optical device preferably implemented to spread a size of an image to be formed on the 2D image sensor, the touch status can be detected by the sensor rows of the 2D image sensor. Then, the exemplary embodiments of present invention provide a row by row readout sequence to increase the refresh rate and detect the touch position of the input device. Furthermore, an extensible device is added into the input device to have contact with the surface of the input device; therefore, the touch pressure of the input device can be detected by utilizing a group by group readout sequence.

Those skilled in the art will readily observe that numerous modifications and alterations of the device and method may be made while retaining the teachings of the invention.

What is claimed is:

1. A method for detecting a touch status of a surface of an input device, comprising:
utilizing a first two-dimension (2D) image sensor disposed at a first location for capturing a first captured image of an object on the surface; and
outputting a plurality of first positions of the object relative to the surface respectively by analyzing horizontal lines of the first captured image.

2. The method of claim 1, further comprising:
adjusting a touch area to be formed on the first 2D image sensor.

3. The method of claim 2, wherein the touch area is adjusted via a cylindrical concave lens.

4. The method of claim 1, wherein the first 2D image sensor includes a plurality of sensor rows, each sensor row corresponds to one horizontal line of the first captured image, and the step of outputting a plurality of first positions of the object relative to the surface respectively by analyzing horizontal lines of the first captured image comprises:
reading the sensor rows one by one to generate a plurality of readout data; and
analyzing at least one readout data of each read sensor row to output the position of the object.

5. The method of claim 1, further comprising:
utilizing a second 2D image sensor, which is disposed at a second location on the surface different from the first location, for capturing a second captured image; and
outputting a plurality of second positions of the object relative to the surface respectively by analyzing horizontal lines of the second captured image.

6. The method of claim 5, wherein one of the first positions and corresponding one of the second positions form a coordinates of the object.

7. The method of claim 1, wherein the object has a first part and a second part, and a touch pressure on the surface is derived by analyzing the first part on the first captured image, wherein the second part has different optical characteristic from the first part.

8. A method for detecting a touch status of a surface of an input device, comprising:
utilizing a two-dimension (2D) image sensor disposed at a first location for capturing a first captured image of an object on the surface, wherein the object have a first part and a second part, wherein the second part has different optical characteristic from that of the first part; and
outputting a touch pressure by a vertical position of the first part in the first captured image.

9. The method of claim 8, wherein the object further comprises an elastic element, and the second part is movably connected to the first part via the elastic element.

10. The method of claim 8, wherein the second part is made of a flexible material and connected to the first part.

11. The method of claim 8, further comprising outputting a plurality of first positions of the object relative to the surface respectively by analyzing horizontal lines of the first captured image.

12. An input device, comprising:
a first two-dimension (2D) image sensor disposed at a first location of a surface, for capturing a first captured image of an object on the surface; and
a touch controller, coupled to the first 2D image sensor, for outputting a plurality of first positions of the object relative to the surface respectively by analyzing horizontal lines of the first captured image.

13. The input device of claim 12, further comprising:
an optical lens, placed in front of the first 2D image sensor, for adjusting a touch area to be formed on the first 2D image sensor.

14. The input device of claim 13, wherein the optical lens is a cylindrical concave lens.

15. The input device of claim 12, wherein the first 2D image sensor includes a plurality of sensor rows, each sensor row corresponds to one horizontal line of the first captured image, and the touch controller comprises:
a readout circuit, for reading the sensor rows of the first 2D image sensor one by one to generate a plurality of readout data; and
an analyzing circuit, for analyzing at least one readout data read by the readout circuit to output the position of the object.

16. The input device of claim 12, further comprising:
a second 2D image sensor, disposed at a second location on the surface different from the first location, coupled to the touch controller, for capturing a second captured image;
wherein the touch controller outputting a plurality of second positions of the object relative to the surface respectively by analyzing horizontal lines of the second captured image.

17. The input device of claim 16, wherein one of the first positions and corresponding one of the second positions form a coordinates of the object.

18. The input device of claim 12, wherein the object has a first part and a second part, and the touch controller further outputs a touch pressure on the surface by analyzing the first part on the first captured image, wherein the second part has different optical characteristic from the first part.

19. An input device, comprising:
an object have a first part and a second part, wherein the second part has different optical characteristic from that of the first part;
a two-dimension (2D) image sensor disposed at a first location of a surface, for capturing a first captured image of the object on the surface; and
a touch controller, coupled to the first 2D image sensor, outputting a touch pressure by analyzing a vertical position of the first part in the first captured image.

20. The input device of claim 19, wherein the object further comprises an elastic element, and the second part is movably connected to the first part via the elastic element.

21. The input device of claim 19, wherein the second part is made of a flexible material and connected to the first part.

22. The input device of claim 19, wherein the touch controller further outputs a plurality of first positions of the object relative to the surface respectively by analyzing horizontal lines of the first captured image.
